(19) United States
(12) Patent Application Publication
(10) Pub. No.: US 2025/0207960 A1
(43) Pub. Date: Jun. 26, 2025

(54) WAIST-SHAPED THROTTLING PHOTON QUANTUM MISCIBLE PHASE FLOWMETER

(71) Applicants: CHENGDU SEA PIONEERS TECHNOLOGY CO., LTD., Chengdu (CN); WUXI SEA PIONEERS TECHNOLOGY CO., LTD., Wuxi (CN); BEIJING PETROLEUM MACHINERY CO., LTD., Beijing (CN)

(72) Inventors: Haibo LIANG, Chengdu (CN); Meng FU, Chengdu (CN); Chao LUO, Chengdu (CN); Jige CHEN, Chengdu (CN); Xianyi LI, Beijing (CN); Kaifu MI, Beijing (CN); Shengjie LU, Beijing (CN); Yu LEI, Beijing (CN); Juncheng WANG, Beijing (CN); Shan SUN, Chengdu (CN)

(21) Appl. No.: 18/781,905

(22) Filed: Jul. 23, 2024

(30) Foreign Application Priority Data
Dec. 21, 2023 (CN) 2023117642989

(51) Int. Cl. G01F 1/661; G01F 1/66; G01F 1/74

(52) U.S. Cl. CPC G01F 1/661; G01F 1/662; G01F 1/74

(57) ABSTRACT

A waist-shaped throttling photon quantum miscible phase flowmeter includes a photon quantum phase fraction device, a photon quantum source, and a photon quantum detector distributed opposite to the photon quantum source, for detecting an energy signal of a single photon quantum emitted by the photon quantum source. A flow channel inside the photon quantum phase fraction device includes a first variable-diameter section, a waist-shaped throat section having a waist-shaped-hole shaped cross section in a direction perpendicular to an axial direction of the flow channel, and a second variable-diameter section that are connected in sequence. Inner diameters of the first and second variable-diameter sections gradually decrease from an end away from the throat section to an end close to the throat section. The photon quantum source and the photon quantum detector are both provided on the photon quantum phase fraction device and located at the throat section.

### Cross Reference to Related Applications

The present disclosure claims priority to the Chinese patent application with the filing No. 2023117642989 filed with the China National Intellectual Property Administration on Dec. 21, 2023, and entitled “WAIST-SHAPED THROTTLING PHOTON QUANTUM MISCIBLE PHASE FLOWMETER”, contents of which are incorporated herein by reference in their entirety.

### TECHNICAL FIELD

The present disclosure relates to the technical field of measurement of industrial miscible phase fluid, and specifically to a waist-shaped throttling photon quantum miscible phase (mixed phase) flowmeter.

### BACKGROUND ART

With the development of oil and gas industry, various miscible phase flowmeters need to be utilized to detect the flow rate of a miscible phase of oil and gas single well and header. Moreover, the miscible phase flowmeters provided in the related art perform phase fraction detection using photon quantum, and can realize flow measurement of various fluid media in miscible phase fluid.

However, accuracy of phase fraction measurement (testing) of the miscible phase flowmeters provided in the related art is affected by many factors including structural design of measurement cross section and the like, and still has a larger room for improvement.

### SUMMARY

The present disclosure aims at providing a waist-shaped throttling photon quantum miscible phase flowmeter, which can improve the accuracy of the phase fraction measurement.

Embodiments of the present disclosure are implemented as follows.

The present disclosure provides a waist-shaped throttling photon quantum miscible phase flowmeter, including:
a photon quantum phase fraction device, wherein the photon quantum phase fraction device is provided therein with a flow channel, the flow channel includes a first variable-diameter section, a waist-shaped throat section and a second variable-diameter section that are connected in sequence, an inner diameter of the first variable-diameter section gradually decreases from an end away from the waist-shaped throat section to an end close to the waist-shaped throat section, an inner diameter of the second variable-diameter section gradually decreases from an end away from the waist-shaped throat section to an end close to the waist-shaped throat section; and in a direction perpendicular to an axial direction of the flow channel, a cross section of the waist-shaped throat section is in a shape of waist-shaped hole;
a photon quantum source, wherein the photon quantum source is provided on the photon quantum phase fraction device, and is located at the waist-shaped throat section; and
a photon quantum detector, wherein the photon quantum detector is provided on the photon quantum phase fraction device, and is distributed opposite to and in parallel with the photon quantum source, and the photon quantum detector is used to detect energy information about a single photon quantum emitted by the photon quantum source.

In an optional embodiment, the waist-shaped throat section includes two planar walls. The two planar walls are distributed opposite to and spaced apart from each other. The photon quantum source is provided on one of the planar walls, and the photon quantum detector is provided on the other planar wall.

In an optional embodiment, the waist-shaped throttling photon quantum miscible phase flowmeter further includes a sensor data acquisition board and a flow computer, and the flow computer is connected to the photon quantum detector through the sensor data acquisition board.

In an optional embodiment, the waist-shaped throttling photon quantum miscible phase flowmeter further includes a multi-parameter sensor provided on the photon quantum phase fraction device, and the multi-parameter sensor is connected to the flow computer through the sensor data acquisition board.

In an optional embodiment, the waist-shaped throat section includes two arc-shaped walls, and the two planar walls are both connected between the two arc-shaped walls.

In an optional embodiment, the photon quantum phase fraction device is provided with a mounting hole and a mounting groove, the photon quantum detector is inserted into the mounting hole, and the photon quantum source is inserted into the mounting groove.

In an optional embodiment, the mounting hole is a through hole, and the photon quantum source is inserted into the mounting groove after passing through the mounting hole.

In an optional embodiment, the waist-shaped throat section is a constant-diameter section.

Beneficial effects of the waist-shaped throttling photon quantum miscible phase flowmeter in the embodiments of the present disclosure include: in the flow channel provided in the photon quantum phase fraction device of the waist-shaped throttling photon quantum miscible phase flowmeter in the embodiments of the present disclosure, the cross section of the waist-shaped throat section is in the shape of waist-shaped hole, which can alleviate the problem that a distance of photon quantum penetrating through a medium is limited, with the photon quantum emitted by the photon quantum source provided at the waist-shaped throat section, and meanwhile the cross section in the shape of waist-shaped hole improves representativeness of photon quantum linear measurement, further guaranteeing the measurement accuracy of the phase fraction, and ensuring the metering accuracy of the whole waist-shaped throttling photon quantum miscible phase flowmeter.

### BRIEF DESCRIPTION OF DRAWINGS

In order to more clearly illustrate technical solutions of embodiments of the present disclosure, drawings which need to be used in the embodiments will be introduced briefly below. It should be understood that the drawings merely show some embodiments of the present disclosure, and thus should not be considered as limitation to the scope, and those ordinarily skilled in the art still could obtain other relevant drawings according to these drawings, without using any inventive efforts.

FIG. 1 is a sectional view of a waist-shaped throttling photon quantum miscible phase flowmeter in embodiments of the present disclosure, from a first viewing angle;

FIG. 2 is a sectional view of a waist-shaped throttling photon quantum miscible phase flowmeter in embodiments of the present disclosure, from a second viewing angle;

FIG. 3 is a structural schematic view of a waist-shaped throttling photon quantum miscible phase flowmeter in embodiments of the present disclosure;

FIG. 4 is a structural schematic view of a photon quantum phase fraction device in embodiments of the present disclosure;

FIG. 5 is a schematic view of photon quantum measurement at a throat section with a cross section in a circular shape in related art; and

FIG. 6 is a schematic view of photon quantum measurement at a waist-shaped throat section in embodiments of the present disclosure.

Reference signs: 010—waist-shaped throttling photon quantum miscible phase flowmeter; 100—photon quantum phase fraction device; 110—flow channel; 111—first variable-diameter section; 112—waist-shaped throat section; 113—second variable-diameter section; 114—first constant-diameter section; 115—second constant-diameter section; 116—planar wall; 117—arc-shaped wall; 121—mounting hole; 122—mounting groove; 200—photon quantum source; 300—photon quantum detector; 310—probe housing; 320—flow computer; 321—differential pressure transmitter; 322—pressure transmitter; 323—valve body; 324—temperature transmitter.

### DETAILED DESCRIPTION OF EMBODIMENTS

In order to make the objectives, technical solutions and advantages of the embodiments of the present disclosure clearer, the technical solutions in the embodiments of the present disclosure will be described clearly and completely below in conjunction with the drawings in the embodiments of the present disclosure. Apparently, only some but not all embodiments of the present disclosure are described. Generally, components in the embodiments of the present disclosure, as described and shown in the drawings herein, may be arranged and designed in various different configurations.

Therefore, the following detailed description of the embodiments of the present disclosure provided in the drawings is not intended to limit the scope of the present disclosure claimed, but merely represents chosen embodiments of the present disclosure. On the basis of the embodiments of the present disclosure, all of other embodiments, obtained by those ordinarily skilled in the art without using any inventive efforts, should fall within the scope of protection of the present disclosure.

It should be noted that like reference signs and letters represent like items in the following drawings. Therefore, once a certain item is defined in one drawing, it does not need to further define or explain the same in subsequent drawings.

In the description of the present disclosure, it should be noted that orientation or positional relationships indicated by terms such as “inner” and “outer” are based on orientation or positional relationships as shown in the drawings, or orientation or positional relationships of a product of the present disclosure when being conventionally placed in use, merely for facilitating describing the present disclosure and simplifying the description, rather than indicating or implying that related devices or elements have to be in the specific orientation or configured and operated in a specific orientation, and thus they should not be construed as limitation to the present disclosure.

In the description of the present disclosure, it should also be noted that, unless clearly defined and limited otherwise, the terms “provide” and “connect” should be understood in a broad sense, for example, it may be a fixed connection, a detachable connection, or integral connection; it may be a mechanical connection or an electrical connection; it may be direct connection, or indirect connection through an intermediary, and it may be internal communication between two components. For those ordinarily skilled in the art, specific meanings of the above-mentioned terms in the present disclosure might be understood according to specific circumstances.

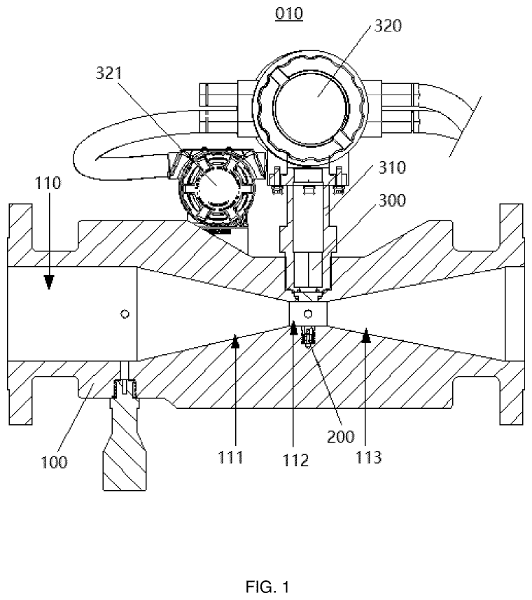

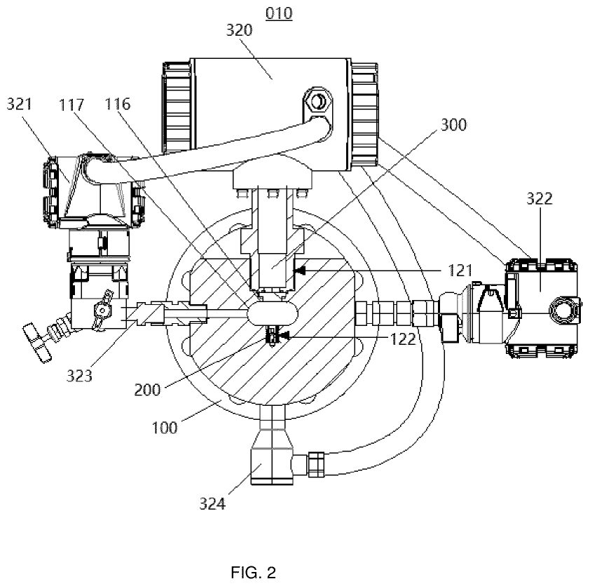

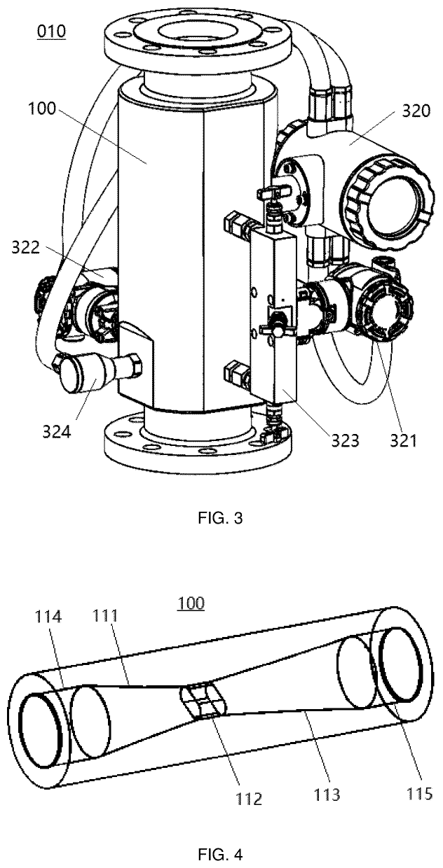

Referring to FIG. 1, FIG. 2 and FIG. 3, the present embodiment provides a waist-shaped throttling photon quantum miscible phase flowmeter 010 for detecting the flow rate of a miscible phase. The miscible phase herein may refer to four phases of oil, gas, water and solid, which is not specifically limited herein.

The waist-shaped throttling photon quantum miscible phase flowmeter 010 includes a photon quantum phase fraction device 100, a photon quantum source 200 and a photon quantum detector 300. Two ends of the photon quantum phase fraction device 100 are each connected to a flange, wherein the flange is used for connecting a measurement pipeline. The photon quantum phase fraction device 100 is also provided with a flow channel 110, and miscible phase in the measurement pipeline may flow through the flow channel 110. The photon quantum source 200 and the photon quantum detector 300 are both provided on the photon quantum phase fraction device 100. The photon quantum source 200 and the photon quantum detector 300 are distributed at two sides of the flow channel 110 in an opposite and spaced manner. The photon quantum detector 300 is used to detect energy information about a single photon quantum emitted by the photon quantum source 200, thereby implementing multi-phase flow detection on a medium flowing through the flow channel 110.

Further, the waist-shaped throttling photon quantum miscible phase flowmeter 010 further includes a sensor data acquisition board and a flow computer 320, wherein the flow computer 320 is connected to the photon quantum detector 300 through the sensor data acquisition board. The flow computer 320 is used to receive a detection signal output by the photon quantum detector 300, so as to correspondingly output detected flow rate of the multi-phase medium.

Optionally, the photon quantum source 200 is a photon quantum source of multiple energy levels, wherein the photon quantum source of multiple energy levels is an exemption-level Ba-133 photon quantum source. The exemption-level Ba-133 photon quantum source has radioactivity of less than 27 microcurie, and the exemption-level Ba-133 photon quantum source generates single photon quantum of four energy levels, namely, energy of 31 keV, 81 keV, 160 keV and 356 keV. By measuring energy of each photon quantum, phase fraction measurement of the miscible phase fluid is completed according to a photoelectric cross section of a photon quantum group of energy of 31 keV, 81 keV and 160 keV and a substance, and Compton cross section of a photon quantum group of energy of 356 keV and a substance.

It should be noted that the above photon quantum (abbreviated as photon) is elementary particle for transmitting electromagnetic interaction, and is a kind of gauge boson. Photon is a carrier of electromagnetic radiation, and in the quantum field theory, photon is considered as medium of electromagnetic interaction. Compared with most elementary particles, static mass of photon is zero, which means that its propagation speed in vacuum is the speed of light. Like other quanta, photon has wave-particle duality: photon can show refraction, interference, diffraction and other properties of classical waves; the particle nature of photon can be proved by photoelectric effect. Photon can only transfer quantized energy, and is a lattice particle and a mass energy phase of a loop quantum particle. The energy of a photon is proportional to frequency of light wave. The higher the frequency is, the higher the energy is. When a photon is absorbed by an atom, an electron gains enough energy to transition from an inner orbit to an outer orbit, and the atom with electronic transition changes from a ground state to an excited state.

A technical route of the miscible phase flowmeter is as follows: 1. measuring phase fraction (generally including gas volume fraction GVF and water content WC); 2. measuring total flow rate Qt; and 3. calculating the flow rate of each phase according to the phase fraction and the total flow rate Qt. Miscible phase flowmeters provided in the related art generally adopt a throttling measurement technique, namely, measuring the total flow rate by measuring a differential pressure generated by a venturi tube; and measuring the phase fraction by rays, that is, through interaction between rays and the substance, detecting the phase fraction by an intensity attenuation/absorption method (specifically, attenuation/absorption degree of ray intensity in different media are different), that is, the photon quantum phase fraction is measured using different mechanisms (including photoelectric effect, Compton scattering and electron pair effect) of interaction between photon quantum with different energies and different substances and different reaction probabilities (cross sections), so as to obtain the phase fraction by analysis. In the above, different reaction mechanisms require different photon quantum energies. The photon quantum energy involved in the photoelectric effect is 100 kEv or less, the photon quantum energy involved in Compton scattering is 100˜1000 kEv, and the electron pair effect requires the photon quantum energy up to 1.022 MEv or more. In other words, interaction between low-energy photon quantum of 100 kEv or less and a substance is mainly photoelectric effect, interaction between higher-energy photon quantum of 100˜1000 kEv and a substance is mainly Compton scattering, and interaction between far-higher-energy photon quantum of 1.022 MEv or more and a substance is mainly electron pair effect.

Full-energy spectrum measurement technique of photon quantum implements coincidence measurement and redundant computation using intensity attenuation of photon quantum of multiple energy levels, and can implement precision measurement of phase fraction of more phases, for example: four phases of oil, gas, water and solid; four phases of oil, gas, water and sulfur; five phases of carbon dioxide/natural gas/crude oil/formation water/sand, etc.

For photon quantum with the energy of 100 kEv or less that has photoelectric effect interaction with a substance, its penetration capacity in the substance is usually between 10 and 30 millimeters. However, in a case where the flowmeter provided in the related art has a size of greater than or equal to DN 100, that is, a nominal diameter of the flowmeter is greater than or equal to 100 millimeters, a throat diameter ratio (β=d/D, throat diameter to nominal diameter) of a venturi tube (i.e., a throttling device) provided therefor needs to be controlled to be 0.35˜0.75, that is to say, a minimum throat diameter of the flowmeter of greater than or equal to DN 100 is 35 millimeters, which exceeds the penetration capacity of the photon quantum with energy of 100 kEv or less in substance, so that detection cannot be carried out reliably for the photon quantum with energy of 100 kEv or less.

In order to alleviate the above problems, and improve the detection accuracy, with reference to FIG. 4, in the present embodiment, the flow channel 110 of the photon quantum phase fraction device 100 is provided to include a first variable-diameter section 111, a waist-shaped throat section 112 and a second variable-diameter section 113 that are connected in sequence and communicate with each other. An inner diameter of the first variable-diameter section 111 gradually decreases from an end away from the waist-shaped throat section 112 to an end close to the waist-shaped throat section 112. An inner diameter of the second variable-diameter section 113 gradually decreases from an end away from the waist-shaped throat section 112 to an end close to the waist-shaped throat section 112. In a direction perpendicular to an axial direction of the flow channel 110, a cross section of the waist-shaped throat section 112 is in a shape of waist-shaped hole; and the photon quantum source 200 and the photon quantum detector 300 are both located at the waist-shaped throat section 112.

The cross section of the waist-shaped throat section 112 is in the shape of waist-shaped hole, which can solve the problem of limited distance of the photon quantum penetrating through the medium, which photon quantum is emitted by the photon quantum source 200 provided at the waist-shaped throat section 112, and meanwhile the waist-shaped cross section improves representativeness of the photon quantum linear measurement, guaranteeing the measurement accuracy of the phase fraction, and further ensuring the measurement accuracy of the whole waist-shaped throttling photon quantum miscible phase flowmeter 010.

Further, with reference to FIG. 2, the waist-shaped throat section 112 includes two arc-shaped walls 117 and two planar walls 116. The two planar walls 116 are distributed opposite to and spaced apart from each other. The two planar walls 116 are both connected between the two arc-shaped walls 117. The photon quantum source 200 is provided on one of the planar walls 116. The photon quantum detector 300 is provided on the other planar wall 116.

The waist-shaped throat section 112 with a cross section in the shape of waist-shaped hole, under a condition that the area of its cross section is the same as that of a throat section with a cross section in a circular hole shape, can reduce a distance between the two opposite planar walls 116 of the waist-shaped throat section 112 in the shape of waist-shaped hole, so that the distance easily meets the requirement of being less than 35 millimeters, and further the detection of the photon quantum with energy of 100 kEv or less can be reliably carried out, that is, the problem that the distance of the photon quantum penetrating through a medium is limited can be solved, and the detection accuracy is ensured.

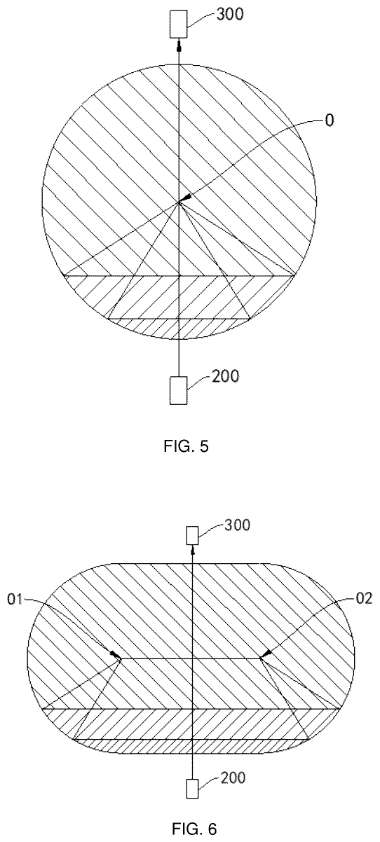

Meanwhile, as shown in FIG. 5 and FIG. 6, when performing photon quantum measurement, in order to reduce influences of scattering, the photon quantum needs to meet narrow beam requirements through structural design of a collimator, that is, when the phase fraction of a cross section is measured through the photon quantum, only one line (as shown in FIG. 5, a straight line indicated by point O, that is, the straight line as central axis of the throat section with a circular cross section) on a path thereof, that is, linear phase fraction on this line is used to represent the phase fraction of a throat cross section of venturi tube in the related art. Only when the miscible phase is uniform, the measured linear phase fraction is equal to the phase fraction of this cross section. That is, only when the miscible phase is uniform, detection result is accurate. However, the miscible phase is flowing in the pipeline, and cannot be ensured to be uniform (as shown in FIG. 5, an uppermost layer is usually a gas phase, a middle layer is usually an oil phase, and a lowermost layer is a water phase), so that the venturi tube in the related art cannot ensure the detection accuracy, particularly, the detection of the water phase near the bottom of the throat section is more affected, and the phase fraction shown by the detection result is obviously larger, which in turn brings about geometric representative errors. In other words, photon quantum narrow beam measurement is essentially sampling measurement, and thus sampling representativeness largely determines the measurement accuracy of the phase fraction, while sampling representativeness of the throat section with a circular cross section is poor, and thus cannot ensure the measurement accuracy.

The phase fraction between the two parallel planar walls 116 is measured by the photon quantum at the waist-shaped throat section 112 of the present embodiment. Specifically, what is actually measured is phase fraction of a cross section formed by extension of a straight line O1O2 along an axial direction of the flow channel 110 as shown in FIG. 6, that is, phase fraction of a cross section formed by a connecting line between a proximal circle center O1 and a distal circle center O2 of the waist-shaped hole, along the axial direction of the waist-shaped throat section 112 shown in FIG. 6. In this way, the geometric representativeness is improved, and even if various phases are completely separated, i.e., phases are unevenly mixed (as shown in FIG. 6, an uppermost layer is usually a gas phase, a middle layer is usually an oil phase, and a lowermost layer is a water phase), the linear phase fraction obtained from detection still well represents the phase fraction of this cross section, i.e., the detection accuracy is ensured. In other words, the structural design of the waist-shaped throat section 112 improves the sampling representativeness of photon quantum linear measurement, thus guaranteeing the accuracy of the phase fraction, and further ensuring metering accuracy of the whole waist-shaped throttling photon quantum miscible phase flowmeter.

In should be noted that with reference to FIG. 5 and FIG. 6, taking water phase and oil phase as an example, under a condition with the same miscible phase, in the waist-shaped throat section 112 and the throat section with a circular cross section which have the same area, depth of a water phase layer in the waist-shaped throat section 112 is less than depth of a water phase layer in the throat section with a circular cross section, and similarly, depth of an oil phase layer in the waist-shaped throat section 112 is less than depth of an oil phase layer in the throat section with a circular cross section.

Optionally, a distance between the two planar walls 116 may be controlled to be 20-30 mm, so that the distance between the photon quantum source 200 and the photon quantum detector 300 that are respectively provided on the two planar walls 116 may reach 20-30 mm, for example, 20 mm, 22 mm, 25 mm, 27 mm, and 30 mm, which is not specifically limited herein. By controlling the distance between the two planar walls 116 to be 20-30 mm, the photon quantum measurement distance can be controlled to be 20-30 mm, thus ensuring the highest accuracy of phase fraction measurement by the photon quantum.

Referring to FIG. 4, in the present embodiment, the waist-shaped throat section 112 is configured as a constant-diameter section, that is, along the axial direction of the flow channel 110, an inner diameter of the waist-shaped throat section 112 keeps consistent, and the inner diameter of the waist-shaped throat section 112 is sized the same as a necking end of the first variable-diameter section 111 as well as a necking end of the second variable-diameter section 113, that is, the inner diameter of the waist-shaped throat section 112 is equal to an inner diameter of an end of the first variable-diameter section 111 connected thereto, and is equal to an inner diameter of an end of the second variable-diameter section 113 connected thereto. With such configuration, flowing smoothness of the medium in the flow channel 110 can be ensured, and detection accuracy and precision are further ensured.

Optionally, the flow channel 110 in the present embodiment further includes a first constant-diameter section 114 and a second constant-diameter section 115. The first constant-diameter section 114 is connected to an end of the first variable-diameter section 111 away from the waist-shaped throat section 112, and an inner diameter of the first constant-diameter section 114 is equal to an inner diameter of a flared end of the first variable-diameter section 111, that is, the inner diameter of the first constant-diameter section 114 is equal to an inner diameter of an end of the first variable-diameter section 111 connected thereto. The second constant-diameter section 115 is connected to an end of the second variable-diameter section 113 away from the waist-shaped throat section 112, and an inner diameter of the second constant-diameter section 115 is equal to an inner diameter of an end of the second variable-diameter section 113 connected thereto.

Optionally, an end of the first constant-diameter section 114 away from the first variable-diameter section 111 is an inlet end, and an end of the second constant-diameter section 115 away from the second variable-diameter section 113 is an outlet end. That is, a miscible phase medium to be detected can enter the flow channel 110 from the end of the first constant-diameter section 114 away from the first variable-diameter section 111, and then flow out from the end of the second constant-diameter section 115 away from the second variable-diameter section 113.

Referring to FIG. 1 and FIG. 2, in the present embodiment, the photon quantum phase fraction device 100 is provided with a mounting hole 121 and a mounting groove 122, wherein the photon quantum detector 300 is inserted into the mounting hole 121, and the photon quantum source 200 is inserted into the mounting groove 122. With such configuration, reliability of assembling the photon quantum detector 300 and the photon quantum source 200 to the photon quantum phase fraction device 100 is ensured, and easy operation of assembling the photon quantum detector 300 and the photon quantum source 200 is ensured.

Further, the mounting hole 121 is a through hole, and the photon quantum source 200 is inserted into the mounting groove 122 after passing through the mounting hole 121. That is, the mounting hole 121 is a through hole penetrating through an outer wall of the photon quantum phase fraction device 100 and an inner wall of the waist-shaped throat section 112, a groove opening of the mounting groove 122 communicates with an inner cavity of the waist-shaped throat section 112, and the photon quantum source 200 can be inserted into the mounting groove 122 from the mounting hole 121 along an axial direction thereof. With such configuration, there is no need to provide a through hole at one side of the waist-shaped throat section 112 of the photon quantum phase fraction device 100 where the mounting groove 122 is provided, thereby reducing a leakage point on the photon quantum phase fraction device 100, and reducing the risk of exposure of the photon quantum.

Certainly, in other embodiments, the waist-shaped throttling photon quantum miscible phase flowmeter 010 further includes a plug; the photon quantum phase fraction device 100 is further provided with an assembling hole communicating with the mounting groove 122, the photon quantum source 200 is inserted into the mounting groove 122 from the assembling hole, and the plug is detachably provided in the assembling hole so as to block the assembling hole. With such configuration, it is convenient to detach the plug from the assembling hole and expose the assembling hole, so as to maintain and replace the photon quantum source 200 assembled in the mounting groove 122, thus it ensures easy maintenance of the waist-shaped throttling photon quantum miscible phase flowmeter 010, and the assembling hole also can be sealed by the plug, thereby reducing the leakage point.

Optionally, the waist-shaped throttling photon quantum miscible phase flowmeter 010 further includes a probe housing 310, the photon quantum detector 300 is provided in the probe housing 310, and the probe housing 310 is inserted into the mounting hole 121, so that the photon quantum detector 300 is inserted into the mounting hole 121 through the probe housing 310. With such configuration, the photon quantum detector 300 can be protected by the probe housing 310, so that problems such as vulnerability of the photon quantum detector 300 to collision and damage are alleviated, and stability of providing the photon quantum detector 300 in the mounting hole 121 also can be improved.

Further, the probe housing 310 is provided with a step portion capable of abutting against the photon quantum phase fraction device 100. That is, the probe housing 310 is inserted into the mounting hole 121, and the step portion abuts against the outer wall of the photon quantum phase fraction device 100. With such configuration, the stability of inserting the photon quantum detector 300 into the mounting hole 121 through the probe housing 310 can be further ensured, further ensuring that the photon quantum detector 300 is reliably distributed opposite to the photon quantum source 200, and ensuring the accuracy and precision of detection result.

With reference to FIG. 1, FIG. 2 and FIG. 3, the waist-shaped throttling photon quantum miscible phase flowmeter 010 in the present embodiment further includes a multi-parameter sensor provided on the photon quantum phase fraction device 100, wherein the multi-parameter sensor is connected to the flow computer through the sensor data acquisition board.

Optionally, the multi-parameter sensor includes a differential pressure transmitter 321 and a pressure transmitter 322. The differential pressure transmitter 321 and the pressure transmitter 322 are both provided on the photon quantum phase fraction device 100, and are both connected to the flow computer 320 through the sensor data acquisition board. With such configuration, the differential pressure transmitter 321 can be used to detect a differential pressure in the flow channel 110, the pressure transmitter 322 can be used to detect a pressure in the flow channel 110, and detection information is sent by the differential pressure transmitter 321 and the pressure transmitter 322 to the flow computer 320, so that instantaneous flow rate and accumulated flow rate of oil-water-gas miscible phase in the flow channel 110 are output by the flow computer 320 according to corresponding detection results.

Furthermore, the waist-shaped throttling photon quantum miscible phase flowmeter 010 further includes a valve body 323, and the differential pressure transmitter 321 is connected at a position corresponding to one of the arc-shaped walls 117 through the valve body 323. With such configuration, the detection accuracy is improved.

Yet further, the valve body 323 is a three-valve assembly, which includes three joints, wherein one joint is connected to the differential pressure transmitter 321; and the other two joints are both connected to the photon quantum phase fraction device 100, and wherein one of the other two joints is connected at a position corresponding to one of the arc-shaped walls 117 of the waist-shaped throat section 112, and the other of the other two joints is connected to the end of the first variable-diameter section 111 away from the waist-shaped throat section 112. Such configuration can further ensure detection accuracy and precision.

With reference to FIG. 1, FIG. 2 and FIG. 3, optionally, the multi-parameter sensor further includes a temperature transmitter 324. The temperature transmitter 324 is provided on the photon quantum phase fraction device 100, and is connected to the flow computer 320 through the sensor data acquisition board. The temperature transmitter 324 can be used to detect temperature in the flow channel 110, and output corresponding detection signal to the flow computer 320, so as to ensure that the flow computer 320 reliably outputs the instantaneous flow rate and the accumulated flow rate of the oil-water-gas miscible phase in the flow channel 110 according to detection signals output by the differential pressure transmitter 321, the pressure transmitter 322 and the temperature transmitter 324.

Optionally, both the temperature transmitter 324 and the pressure transmitter 322 are located at the end of the first variable-diameter section 111 away from the waist-shaped throat section 112. With such configuration, the detection accuracy of the temperature transmitter 324 and the pressure transmitter 322 can be ensured.

Further, the temperature transmitter 324 and the pressure transmitter 322 are both provided at the end of the first constant-diameter section 114 close to the first variable-diameter section 111. Alternatively, the temperature transmitter 324 and the pressure transmitter 322 are both located at junction of the first constant-diameter section 114 and the first variable-diameter section 111.

It should be noted that detection principles of the differential pressure transmitter 321, the pressure transmitter 322 and the temperature transmitter 324, as well as principles of the flow computer outputting the instantaneous flow rate and the accumulated flow rate of the oil-water-gas miscible phase in the flow channel 110 through the detection signals of the differential pressure transmitter 321, the pressure transmitter 322 and the temperature transmitter 324 are similar to those in the related art, which are not further described herein.

In conclusion, the waist-shaped throttling photon quantum miscible phase flowmeter 010 in the present disclosure can be used to detect the miscible phase flow rate, and can improve the measurement accuracy.

The above are merely preferred embodiments of the present disclosure and not used to limit the present disclosure. For those skilled in the art, various modifications and changes might be made to the present disclosure. Any modifications, equivalent substitutions, improvements and the like made within the spirit and principle of the present disclosure should be covered within the scope of protection of the present disclosure.

What is claimed is:

1. A waist-shaped throttling photon quantum miscible phase flowmeter, comprising:
a photon quantum phase fraction device, wherein the photon quantum phase fraction device is provided therein with a flow channel, the flow channel comprises a first variable-diameter section, a waist-shaped throat section and a second variable-diameter section that are connected in sequence, an inner diameter of the first variable-diameter section gradually decreases from an end thereof away from the waist-shaped throat section to an end thereof close to the waist-shaped throat section, an inner diameter of the second variable-diameter section gradually decreases from an end thereof away from the waist-shaped throat section to an end thereof close to the waist-shaped throat section; and in a direction perpendicular to an axial direction of the flow channel, a cross section of the waist-shaped throat section is in a shape of waist-shaped hole;
a photon quantum source, wherein the photon quantum source is provided on the photon quantum phase fraction device, and is located at the waist-shaped throat section; and
a photon quantum detector, wherein the photon quantum detector is provided on the photon quantum phase fraction device, and is distributed opposite to and in parallel with the photon quantum source, and the photon quantum detector is configured to detect energy information about a single photon quantum emitted by the photon quantum source.

2. The waist-shaped throttling photon quantum miscible phase flowmeter according to claim 1, wherein the waist-shaped throat section comprises two planar walls, the two planar walls are distributed opposite to and spaced apart from each other, the photon quantum source is provided on one of the planar walls, and the photon quantum detector is provided on the other planar wall.

3. The waist-shaped throttling photon quantum miscible phase flowmeter according to claim 2, wherein the waist-shaped throttling photon quantum miscible phase flowmeter further comprises a sensor data acquisition board and a flow computer, and the flow computer is connected to the photon quantum detector through the sensor data acquisition board.

4. The waist-shaped throttling photon quantum miscible phase flowmeter according to claim 3, wherein the waist-shaped throttling photon quantum miscible phase flowmeter further comprises a multi-parameter sensor provided on the photon quantum phase fraction device, and the multi-parameter sensor is connected to the flow computer through the sensor data acquisition board.

5. The waist-shaped throttling photon quantum miscible phase flowmeter according to claim 2, wherein the waist-shaped throat section further comprises two arc-shaped walls, and the two planar walls are both connected between the two arc-shaped walls.

6. The waist-shaped throttling photon quantum miscible phase flowmeter according to claim 1, wherein the photon quantum phase fraction device is provided with a mounting hole and a mounting groove, the photon quantum detector is inserted into the mounting hole, and the photon quantum source is inserted into the mounting groove.

7. The waist-shaped throttling photon quantum miscible phase flowmeter according to claim 6, wherein the mounting hole is a through hole, and the photon quantum source is inserted into the mounting groove after passing through the mounting hole.

8. The waist-shaped throttling photon quantum miscible phase flowmeter according to claim 1, wherein the waist-shaped throat section is a constant-diameter section.

9. The waist-shaped throttling photon quantum miscible phase flowmeter according to claim 2, wherein a distance between the two planar walls is 20-30 mm.

10. The waist-shaped throttling photon quantum miscible phase flowmeter according to claim 2, wherein the photon quantum phase fraction device is provided with a mounting hole and a mounting groove, the photon quantum detector is inserted into the mounting hole, and the photon quantum source is inserted into the mounting groove.

11. The waist-shaped throttling photon quantum miscible phase flowmeter according to claim 3, wherein the photon quantum phase fraction device is provided with a mounting hole and a mounting groove, the photon quantum detector is inserted into the mounting hole, and the photon quantum source is inserted into the mounting groove.

12. The waist-shaped throttling photon quantum miscible phase flowmeter according to claim 4, wherein the photon quantum phase fraction device is provided with a mounting hole and a mounting groove, the photon quantum detector is inserted into the mounting hole, and the photon quantum source is inserted into the mounting groove.

13. The waist-shaped throttling photon quantum miscible phase flowmeter according to claim 5, wherein the photon quantum phase fraction device is provided with a mounting hole and a mounting groove, the photon quantum detector is inserted into the mounting hole, and the photon quantum source is inserted into the mounting groove.

14. The waist-shaped throttling photon quantum miscible phase flowmeter according to claim 2, wherein the waist-shaped throat section is a constant-diameter section.

15. The waist-shaped throttling photon quantum miscible phase flowmeter according to claim 3, wherein the waist-shaped throat section is a constant-diameter section.

16. The waist-shaped throttling photon quantum miscible phase flowmeter according to claim 4, wherein the waist-shaped throat section is a constant-diameter section.

17. The waist-shaped throttling photon quantum miscible phase flowmeter according to claim 5, wherein the waist-shaped throat section is a constant-diameter section.
